(19) United States
(12) Patent Application Publication
(10) Pub. No.: US 2004/0249643 A1
(43) Pub. Date: Dec. 9, 2004

(54) Web-based computer programming method to automatically fetch, compare, and update various product prices on the web servers

(75) Inventors: Lien Ouyang, Los Altos, CA (US); Michael Han, San Jose, CA (US); Abraham C. Ma, Fremont, CA (US)

Correspondence Address: TROXELL LAW OFFICE PLLC, Suite 1404, 5205 Lessburg Pike, Falls Church, VA, 22041, US

(73) Assignee: MA LABORATORIES, INC.

(21) Appl. No.: 10/455,378

(22) Filed: Jun. 6, 2003

(51) Int. Cl. G06F 17/60

(52) U.S. Cl. 705/1; 705/400

(57) ABSTRACT

A method utilizes a keyword based rule set to crawl through the web pages and fetch the related product prices. There are many algorithms involved for accurately matching and selecting the required items. The data is then sorted by the price and brand and compared with the database of a group of known products. The prices of the known products are then adjusted via a set of built-in rules to put them in a very competitive position, such as number 1 or 2 among the same product category. The new prices make the seller's products very competitive online. The new price list will then automatically be posted to the web server to replace the old prices. The whole process is automated by simply placing the program on a computer operating system scheduler and let it run periodically according to the specified date and time.

### BACKGROUND OF THE INVENTION

1. Field of the Invention

The invention consists of the automation and computerization of a number of manual process steps related to searching, filtering, comparing, adjusting, and updating the online store product prices on the web servers. The concept is developed into a computer program with a set of rules and database.

2. Description of the Related Art

In the e-commerce world on the Internet, many websites offer online stores for sellers to list their products so buyers can shop online. The most famous price comparison websites are PriceWatch, eBay and Yahoo, etc. A seller can open an account on those websites and list thousands of products for sale. The attributes associated with each product listing consist of brand name, description, and price. Unlike the traditional stores, people can shop online 24 hours a day, 7 days a week. There is essentially no time and space restriction for the online store to stay open for business. The competition is therefore very severe.

To keep its products competitive, a seller must be aware of the current market situation and adjust its listing prices to be the most attractive among all the competing stores. To achieve that, a seller must first surf through many web pages to find the prices of the same product listed by his competitors. Secondly, he has to compare its price with them and thirdly, adjust it accordingly and post it back to its online store. Imagine how many human hours are required to do this for hundreds of products, and the possible human errors that may occur. FIG. 1 shows a typical process of the manual steps involved.

### SUMMARY OF THE INVENTION

The invention has been accomplished under the circumstances in view. It is the main objective of the present invention to provide a process that automatically fetches, compares and updates product prices on the web servers. It is another objective of the present invention to provide a pattern matching and searching method, which is practical for use to search for the same product listed online. The method comprises a database with item codes, keywords, and filtering codes, and three pattern match algorithms. In general, the method utilizes a keywords based rule set for a seller to crawl through the web pages and fetch competitors' prices of the related products. There are many algorithms involved for accurately matching and selecting the required items. The data is then sorted by the price and brand and compared with that of a group of seller's known products. The prices of the known products are then adjusted via a set of built-in rules to put them in a more competitive position, such as number 1 or 2 for the same product category among the online stores. The new price list will then automatically be posted to seller's own store on the web server to replace the old prices. The new prices make the seller's products very competitive. The whole process is automated by simply placing the program on a computer operating system scheduler and let it run periodically according to the specified date and time.

### BRIEF DESCRIPTION OF THE DRAWING

FIG. 1 shows a manual update process according to the prior art.

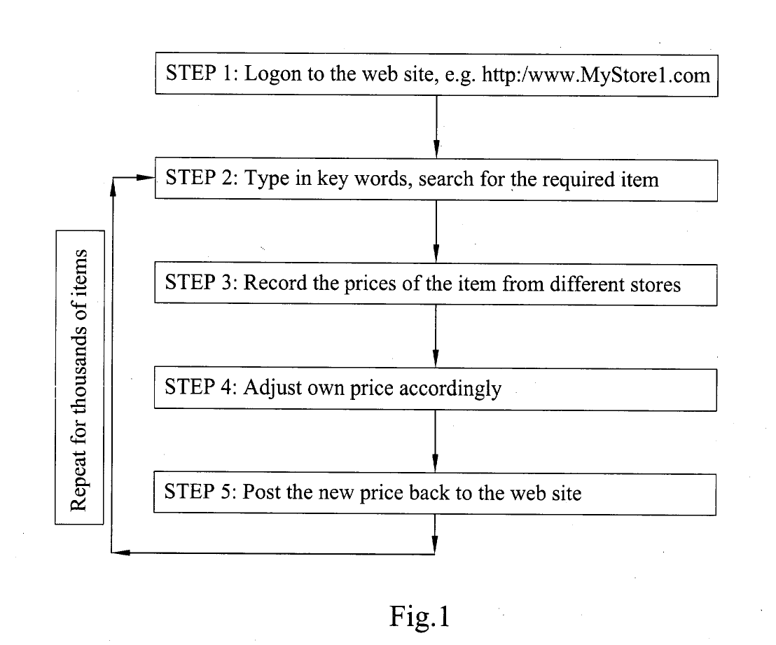

FIG. 2 shows a computerized update process according to the present invention.

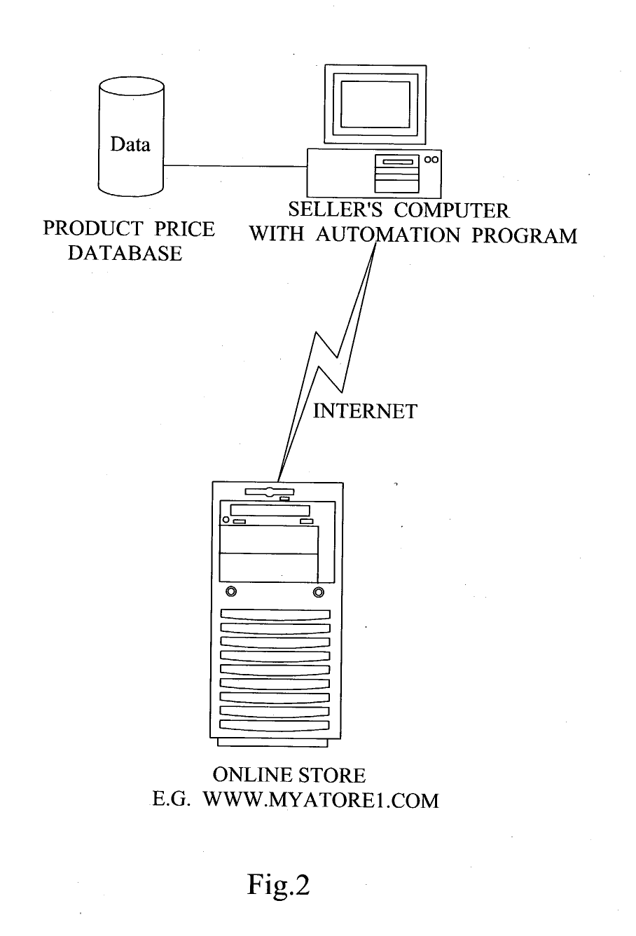

### DETAILED DESCRIPTION OF THE INVENTION

To expedite this tedious and time consuming process, and avoid all potential human errors, a computer programming method which automates the five manual steps has been developed. The program employs a keyword and a price database of known products, and utilizes several item searching and matching algorithms to crawl through a web server collecting product prices from competing stores. The collected data is sorted and compared with those in the database. The prices in the database are then adjusted according to the current market trend and posted back to seller's own store on the web server.

The database consists of three attributes that are described below:

(1) Item codes—The manufacturer or vendor's part number, e.g. INC766FC, CPC-0033.

(2) Keywords—The words used to search the desired item on the web server. They are used in logical AND way, e.g. “IBM PRO 1200×2400 USB”, “PC133 REGISTER ECC 512 MB”.

(3) Filtering codes—Some items have the matching keywords embedded in their product descriptions, but are not really the sought after items. For example if an item has the words “PC133 REGISTER ECC 256 MB 512 MB 1.0 GB . . . ” in its description, then it will be selected by the program using the keywords “PC133 REGISTER ECC 512 MB”. And it must be filtered out because only the 512 MB items are wanted. There are products that will have certain characteristics, such as “W/ TVOUT”, “W/O TVOUT”, etc. Then both items with and without “TVOUT” will be selected if “TVOUT” is among the keywords. The filtering is needed for this item but can be eliminated if the search algorithm is extended to including a “NOT” logic. Moreover, some manufacturers do not need to be considered in the price competition, so a code is also set up to filter certain companies out.

The items must be selected from competing stores on the web server as accurately as possible to ensure the proper prices are compared with and the most economical and competitive price is posted back to seller's own store on the web server. To achieve that, the following keyword matching algorithms are implemented in the program:

(1) There may be some slight differences in the wording that vendors put in the description for their products. For instance the words “ultra-ata148”, “ultra*ata148”, “ultra ata148”, and “ultra/ata148” may all be used to describe the same feature of an item. So the program uses a wild card character “/” to combine two sub-words into one keyword. In the above case, the keyword “ultra/ata148” will also match the other three descriptions.

(2) The vendors may also use the following wordings to describe the opposite of a product feature, e.g. “non-trilight”, “no-trilight”, “not-trilight”, and “without-trilight” all have the same meaning. So the program uses “non” as a wild card for negative meaning, that is the keyword “non-*****” will also match “non-*****”, “no-*****”, “not-*****”, and “without-*****” within product descriptions.

(3) There are certain conventions used to describe some product features, e.g. “10K RPM” for “10000 RPM”, “15K MHZ” for “15000 MHZ”, and “256M” for “256 MB”, “20.0 G” for “20.0 GB”. So the program treats “10K” and “10000”, “256M” and “256 MB”, etc. as the same keyword during the search.

The selected items have all the keywords embedded in their respective product descriptions. However, some of them may have features different from the desired one and must be filtered out. For examples, a product with the description “. . . 32 bit and 64 bit dual interface . . . ” will be selected if “32 bit” is among the keyword set, but the desired interface card has only 32 bit single interface. Or a generic house brand with the description “. . . IBM compatible 500 MHZ . . . ” will be selected if “IBM” is among the keyword set, but only the IBM brand is desired. The program's filtering logic will be applied to such items and filters out the unwanted ones.

The price comparison websites may list the prices in either of two ways. Some websites simply list product prices. These websites include YAHOO, EBAY, PRICESCAN, etc. Some other websites list product prices as well as shipping cost and state tax. The shipping cost and state tax are added to the product price, showing a final price, which is listed side by side with the product price. Those websites include DEALTIME, BIZRATE, PRICEGRABBER, PRICEWATCH, etc. Because the shipping cost and state tax are dependent on buyer's location, the final price of the product varies for customers.

In order to prevent inconsistency of the ranking of product price versus final price due to the variation of shipping cost and state tax, the computer program compares the price of same product as well as the corresponding final price. Further, in order to exempt state tax, the program will examine the address of the buyer who placed an order to decide whether to ship the order from the local state or a branch office in another state. Thus the buyer does not need to pay state tax. The aforesaid transaction procedure is suitable for US and Canada. Similar automatic selling programs may be developed subject to actual conditions for use in Asian or European countries.

Finally, after the prices of the same product are obtained from the web server and sorted in ascending order, the seller's price will be adjusted to be the most competitive one by using a set of built-in rules in the program. The rules take into consideration of a number of factors: number of items on the market, the lowest price, the second lowest price, and the seller's cost, shipping/handling cost, profit margin, etc. The program will adjust the seller's product price to a near optimum and repost it to the web server automatically. The price of a particular item will be adjusted by the following criteria:

(4) The seller's base price is the cost, plus certain percentage (e.g. 8%) markup as well as the shipping and insurance charges. This price is compared with the lowest price collected from the price comparison website. If the seller's price is lower, it means the seller has set its price too low. So the price will be adjusted up, for example, according to the following formula:

Final_price=Lowest_price−parameter1

Where parameter1 is set to Lowest_price multiplied by a small factor, e.g. 0.00005, or just a small fixed number if the price is less than a certain threshold. The effect is to set the seller's price just a little lower than the current market's lowest price by at least one cent.

(5) If the seller's price is higher, then it means the seller should lower its price. The program will adjust the price down, for example, according to the following rules:

If

(Seller_price−Lowest_price)<parameter2

Where parameter2 is a preset constant, e.g. 10.

And

(Seller_price−Lowest_price)/Lowest_price<parameter3

Where parameter3 is a small fraction, e.g. 0.0025.

Then

Final_price=Lowest_price−parameter4

Where parameter4 is Lowest_price multiplied by a small factor, e.g. 0.00005

The parameters in the above formula may be adjusted according to the products and their price structures in the online market place.

(6) If seller's price does not satisfy the two conditions in the formula above, it means the seller's cost is too high and cannot compete with other vendors online. This product may be removed from the selling list and replaced with a new product selected automatically by the program. But sometimes although the cost of a product is too high, the seller still choose to sell it at no profit or at a small loss due to the strategy of gaining market share and increasing sales of other related products at profit. Whether to sell a product at loss or to replace it with a new one, the program will decide based on the market demand and to set the product price accordingly.

(7) The same process will be done daily for thousands of product. A ranking list for each product is compiled and printed everyday for reference. New product will be selected from the list based on the current market demand. If more vendors are found selling the same product, it means this product could be very popular, and then the program will select it first. And the pricing criteria can be easily adjusted to set seller's price to be the second or third competitive position, by simply replacing the “Lowest_price” within the formula in (5) with the “Second_lowest_price” or “Third_lowest_price”.

(8) Many e-commerce companies have their products listed on several price comparison websites or major search engines, with “Buy online” hyper link to their own e-commerce website to complete the sale. In order to stay competitive, it is necessary to adjust product prices for different price comparison websites. This requires the e-commerce website to support a multi-pricing structure. Multi-pricing support is achieved by first recognizing which price comparison website a buyer is linked from. Then the proper price for that specific price comparison website is selected and displayed. To ensure the displayed price on the e-commerce website is the same as the price comparison website, whenever a price adjustment is made on the price comparison website, the same adjustment must be done on the e-commerce website too. They are done automatically in synchronization by the computer program of this invention.

(9) To prohibit certain computer programs from keeping linked thereto to use the computer resource indefinitely, some price comparison websites detect external connection status and cut off the linking that have exceeded the time permitted. The program of this invention adopts a special linking method to overcome this hurdle, i.e. if the linking is disconnected by the price comparison website before completion of task, the program automatically reconnects itself back and continues fetching and analyzing data from the last point of disconnection, there is no need to start all over again from the beginning. Basically, the design uses a multithread control, i.e. it uses a parent thread to monitor the child thread. When the child thread is disconnected by the price comparison website, the parent thread produces a child thread again, which knows the point of disconnection from a log file, and resumes running from that particular point. The parent thread exits on its own after the completion of task.

What is claimed is:

1. A web-based computer programming method adapted to automatically fetch, compare, and update a plurality of product prices on web servers, the method comprising the steps of:
(a) A seller employing a keyword and a price database and utilizing item searching and matching algorithms to crawl through a web server to obtain competitors' selling prices of predetermined products, and then sorting collected data in ascending order; and
(b) Comparing collected data with prices of same products stored in said price database and then adjusting the prices in said price database to be the most competitive based on a set of built-in rules in the program, and then reposting the adjusted prices to seller's own store on the web server.

2. The web-based computer programming method as in claim 1, wherein the employment of said keyword includes a sub-step of using a filtering logic to filter out the unwanted ones from searched products, said filtering logic including wordings that describe the opposite meaning of a feature and conventions that are being used to describe some product features.

3. The web-based computer programming method as in claim 1, wherein said price database has a table stored therein, said table including item codes, keywords, and filtering codes.

4. The web-based computer programming method as in claim 2, wherein said item codes are manufacturers or vendors' part numbers.

5. The web-based computer programming method as in claim 2, wherein said keywords are used in logical AND way to search the desired items in the web server.

6. The web-based computer programming method as in claim 2, wherein said filtering codes are adapted to filter out some items that have the matching keywords embedded in their product descriptions, but are not the items the program is looking for.

7. The web-based computer programming method as in claim 1, wherein said built-in rule takes into consideration of a number of factors including the number of items on the market, the lowest price, the second lowest prices, and the seller's cost, shipping and handling cost, profit margin, etc.

8. The web-based computer programming method as in claim 1, wherein when adjusting the price of an assigned product listed in said price database, it is subject to the rule in which the seller's base price is the cost and the seller's price is higher than the lowest price on the market.

9. The web-based computer programming method as in claim 8, wherein said seller's base price is the cost, plus a predetermined percentage markup and the shipping and insurance charges, said base price is compared with the lowest price on the market.

10. The web-based computer programming method as in claim 9, wherein If the seller's price is lower than that, then it may mean the seller sets the price too low, and the price will be adjusted up according to a predetermined formula: Final_price=Lowest_price−parameter 1, said parameter1 being set to Lowest_price multiplied by a small factor, enabling the seller's price just to be a little lower than the current market's lowest price by at least one cent.

11. The web-based computer programming method as in claim 9, wherein the program adjusts the price down subject to said built-in rule If the seller's price is higher than market's lowest price.

12. The web-based computer programming method as in claim 11, wherein the program adjusts the price down subject to a formula set in said built-in rule, said formula being adjusted and varied according to the categories of the products and their price structures in the online market place as follows:
If
(Seller_price−Lowest_price)<parameter2
Where parameter2 is a preset constant
And
(Seller_price−Lowest_price)/Lowest_price<parameter3
Where parameter3 is a small fraction
Then
Final_price=Lowest_price−parameter4
Where parameter4 is Lowest_price multiplied by a small factor.

13. The web-based computer programming method as in claim 12, wherein if the seller's price does not satisfy the defined conditions, the program then removes the item from the selling list and replace it with a new product based on the market demand and set the price accordingly.

14. The web-based computer programming method as in claim 12, wherein if the seller's price does not satisfy the defined conditions, the program then decides to sell it at no profit or at loss due to marketing strategy of gaining market share and increasing sales of other related products at profit. The program will decide based on the market demand and adjust the product price accordingly.

15. The web-based computer programming method as in claim 13, wherein the program compiles and prints out ranking list for all products in the database for reference daily, selects new items from the list based on the current market demand, subject to the rule that if more vendors found on the market for the same product, then it means this product could be very popular, and adjusts the pricing criteria to set the seller's price to be the second or third competitive by replacing the “Lowest_price” in the formula with the “Second_lowest_price” or “Third_lowest_price”, enabling the new price to be put in the desired position.

16. The web-based computer programming method as in claim 1, wherein the price on seller's own e-commerce website is maintained consistent with the price on the specific price comparison website from which a buyer is hyper linked with the e-commerce website, meaning the e-commerce website supports multi-pricing structure, and whenever a price adjustment is made on the price comparison website, the same adjustment is also made automatically on the e-commerce website by said web-based computer program in synchronization.
